(19) United States
(12) Patent Application Publication
(10) Pub. No.: US 2018/0251037 A1
(43) Pub. Date: Sep. 6, 2018

(54) RETRACTABLE JUMPER CABLE VEHICLE ASSEMBLY

(71) Applicant: Ford Global Technologies, LLC, Dearborn, MI (US)

(72) Inventors: Raul Ezequiel Alvarez Ruiz, Mexico D.F. (MX); Alfonso Hickman Guevara, Tlalnepantla (MX); Cuauhtemoc Quiroz Garfias, Mexico (MX); Luis Jesus Chavela Guerra, Mexico D.F. (MX); Eloy Ernesto Camargo Corral, Mexico City (MX)

(21) Appl. No.: 15/449,546

(22) Filed: Mar. 3, 2017

(51) Int. Cl. B60L 11/18

(52) U.S. Cl. CPC B60L 11/1818; B60L 11/1861

(57) ABSTRACT

Method and apparatus are disclosed for retractable jumper cable vehicle assembly. An example vehicle includes an exterior surface, a battery, a retractable cable, a jumper plug coupled to the retractable cable and electrically connected to the battery via the retractable cable, and a compartment along the exterior surface to house the jumper plug when the retractable cable is retracted. When the retractable cable is extended, the jumper plug extends from the compartment to connect to a receptacle of another vehicle.

### TECHNICAL FIELD

The present disclosure generally relates to jumper cables and, more specifically, to retractable jumper cable vehicle assembly.

### BACKGROUND

Typically, vehicles include a starter battery to activate an engine (e.g., an internal combustion engine, an electric motor, etc.). Once the engine is activated, power is supplied to the engine via an alternator. In some instances, the starter battery may be discharged, thereby preventing the engine from being activated. In such instances, jumper cables oftentimes are utilized to recharge (e.g., temporarily and/or partially) the battery and/or to activate the motor.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments are shown for retractable jumper cable vehicle assembly. An example disclosed vehicle includes an exterior surface, a battery, a retractable cable, a jumper plug coupled to the retractable cable and electrically connected to the battery via the retractable cable, and a compartment along the exterior surface to house the jumper plug when the retractable cable is retracted. When the retractable cable is extended, the jumper plug extends from the compartment to connect to a receptacle of another vehicle.

An example disclosed vehicle includes an exterior surface and a compartment located along the exterior surface. The compartment includes a wall defining an aperture and a jumper receptacle fixed to the wall and configured to receive a plug of another vehicle to electrically connect vehicle batteries. The example disclosed vehicle also includes a retractable cable partially positioned through the aperture and a jumper plug coupled to the retractable cable and housed in the compartment when the retractable cable is retracted.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 illustrates a vehicle including an example retractable jumper cable assembly as disclosed in the teachings herein.

FIG. 2 is a schematic of the retractable jumper cable assembly of FIG. 1.

FIG. 3 is a front view of a compartment of the retractable jumper cable assembly of FIG. 1.

FIG. 4 is a block diagram of electronic components of the vehicle of FIG. 1.

FIG. 5 is a flowchart for jumping a battery of a vehicle via the retractable jumper cable assembly of FIG. 1 in accordance with the teachings herein.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

Oftentimes, vehicles include a starter battery to activate an engine (e.g., an internal combustion engine, an electric motor, etc.). Once the engine is activated, power is supplied to the engine via an alternator. In some instances, the starter battery may be discharged, thereby preventing the engine from being activated. For example, the battery may become discharged if lights of the vehicle remain activated for an extended period of time after the engine of the vehicle is deactivated. In such instances, jumper cables oftentimes are utilized to recharge (e.g., temporarily and/or partially) the battery and/or to activate the motor.

Typically, to utilize jumper cables to jump a vehicle battery, a user attaches a first set of clamps of the jumper cables to leads of the vehicle battery that is discharged and attaches a second set of clamps of the jumper cables to leads of a battery that is charged. However, if the user of the vehicle with the discharged battery does not store jumper cables in the vehicle, the user potentially may have to wait to jump his vehicle until finding someone that does include jumper cables in her vehicle. Further, both the user of the vehicle with the discharged vehicle and the user of the vehicle with the charged vehicle potentially may be unfamiliar and/or uncomfortable with the process of connecting the jumper cables to the batteries via the clamps.

Example apparatus and methods disclosed herein include an easily-accessible retractable jumper cable assembly that is fixed to a battery of a vehicle to facilitate a user in quickly jumping a discharged battery of the vehicle. Example vehicles disclosed herein include a starter battery, an exterior surface, and a compartment located along the exterior surface. The compartment includes a wall that defines an aperture and a door that is coupled to the exterior surface. The door encloses the compartment when in a closed position and provides access to the compartment when in an open position. Further, the compartment houses a jumper plug (i.e., a male electrical connector) and a jumper receptacle (i.e., a female electrical connector) that are configured to electrically connect the battery of the vehicle to another battery of another vehicle to jump one of the batteries. For example, the jumper receptacle and the jumper plug are electrically connected to the battery of the vehicle. As used herein, “jumping” and “jump starting” a battery refers to a process in which an electrical connection is made between a charged starter battery of one vehicle and a discharged starter battery of another vehicle such that the charged battery partially recharges the discharged battery and activates an engine of the other vehicle.

The jumper receptacle of the example vehicles is fixed to the wall of the compartment and is configured to receive a plug (e.g., another jumper plug) of the other vehicle to electrically connect the batteries of the vehicles. For example, the jumper receptacle is electrically connected to the battery via a receptacle cable that is coupled to the jumper receptacle.

The jumper plug of the example vehicles is coupled to a retractable cable of the vehicle and is electrically connected to the battery of the vehicle via the retractable cable. The retractable cable is partially positioned through the aperture of the wall of the compartment such that the jumper plug is housed in the compartment when the retractable cable is retracted and extends from the compartment when the retractable cable is extended. The jumper plug is to connect to a receptacle (e.g., another jumper receptacle) of the other vehicle when the retractable cable is extended to electrically connect the batteries of the vehicles. The example vehicles include a retractor that is connected to the retractable cable to enable the retractable cable and, thus, the jumper plug to retract and extend.

In some examples, the jumper plug includes one or more flanges and the jumper receptacle includes one or more corresponding slots to facilitate secure connections to the other vehicle. To securely connect the jumper plug of the vehicle to the receptacle of the other vehicle, the flanges of the jumper plug are inserted into a cavity through corresponding slots of the receptacle and rotated within the cavity of the receptacle. Similarly, to securely connect the jumper receptacle of the vehicle to the plug of the other vehicle, the slots are to receive corresponding flanges of the plug.

Example vehicles disclosed herein also include a connection module to detect when the battery of the vehicle is electrically connected to the other battery of the other vehicle. For example, the connection module is electrically connected to the battery via battery cables that couple to the battery and the connection module. The retractable cable is coupled to the connection module such that the jumper plug is electrically connected to the battery via the retractable cable, the connection module, and the battery cables. Further, the receptacle cable is coupled to the connection module such that the jumper receptacle is electrically connected to the battery via the receptacle cable, the connection module, and the battery cables.

In some examples, the connection module detects that the battery of the vehicle is electrically connected to the other battery of the other vehicle when the jumper plug of the vehicle is connected to the receptacle of the other vehicle and/or when the jumper receptacle of the vehicle is connected to the plug of the other vehicle. In some examples, the connection module detects a charge level (e.g., a first charge level) of the battery of the vehicle, detects a another charge level (e.g., a second charge level) of the other battery of the other vehicle, and determines whether the battery of the vehicle is providing energy to or receiving energy from the other battery of the other vehicle by comparing the charge levels of the batteries. As used herein, a “charge level” and a “state-of-charge” of a battery refers to a measurement of an amount of energy stored within a battery. In some examples, the charge lever or state-of-charge is measured as a percentage of which 0% represents a fully discharged battery and 100% represents a fully charged battery.

Further, in some examples, the vehicle includes a display that presents the charge level of the battery of the vehicle and/or the other charge level of the other battery of the other vehicle upon receiving a signal from the connection module to do so. Additionally or alternatively, the compartment includes an indicator that present the charge level of the battery of the vehicle upon receiving a signal from the connection module to do so.

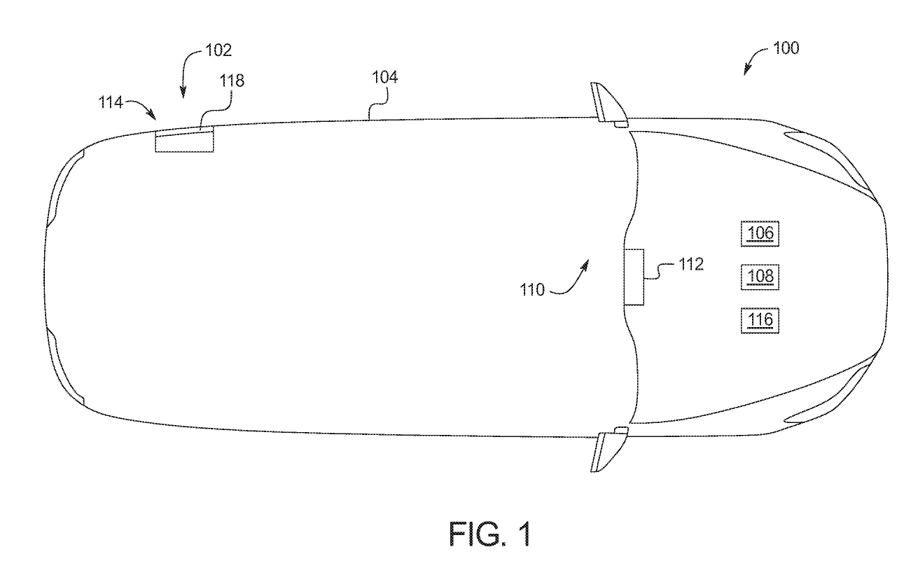

Turning to the figures, FIG. 1 illustrates a vehicle 100 including an example retractable jumper cable assembly 102 in accordance with the teachings herein. The vehicle 100 may be a standard gasoline powered vehicle, a hybrid vehicle, an electric vehicle, a fuel cell vehicle, and/or any other mobility implement type of vehicle. The vehicle 100 includes parts related to mobility, such as a powertrain with an engine, a transmission, a suspension, a driveshaft, and/or wheels, etc. The vehicle 100 may be non-autonomous, semi-autonomous (e.g., some routine motive functions controlled by the vehicle 100), or autonomous (e.g., motive functions are controlled by the vehicle 100 without direct driver input). In the illustrated example, the vehicle 100 includes the retractable jumper cable assembly 102, an exterior surface 104, an engine 106, a battery 108, and an infotainment head unit 110.

The engine 106 of the illustrated example includes an internal combustion engine, an electric motor, and/or any other power source that propels movement of the vehicle 100. The battery 108 (e.g., a starter battery) provides energy to the engine 106 to activate the engine 106. Once activated, power is supplied to the engine 106 via an alternator.

The infotainment head unit 110 provides an interface between the vehicle 100 and a user. The infotainment head unit 110 includes digital and/or analog interfaces (e.g., input devices and output devices) to receive input from and display information for the user(s). The input devices include, for example, a control knob, an instrument panel, a digital camera for image capture and/or visual command recognition, a touch screen, an audio input device (e.g., cabin microphone), buttons, or a touchpad. The output devices may include instrument cluster outputs (e.g., dials, lighting devices), actuators, a display 112 and/or speakers. For example, the display 112 may include a heads-up display and/or a center console display (e.g., a liquid crystal display (LCD), an organic light emitting diode (OLED) display, a flat panel display, a solid state display, etc.). In the illustrated example, the infotainment head unit 110 includes hardware (e.g., a processor or controller, memory, storage, etc.) and software (e.g., an operating system, etc.) for an infotainment system (such as SYNC® and MyFord Touch® by Ford®, Entune® by Toyota®, IntelliLink® by GMC®, etc.). Additionally, the infotainment head unit 110 displays the infotainment system on, for example, the display 112.

The retractable jumper cable assembly 102 of the illustrated example enables the battery 108 of the vehicle 100 to jump a battery of another vehicle and/or enables the battery of the other vehicle to jumper the battery 108 of the vehicle 100. As illustrated in FIG. 1, the retractable jumper cable assembly 102 includes a compartment 114 and a connection module 116.

The compartment 114 is located along the exterior surface 104 of the vehicle 100 to facilitate access to the retractable jumper cable assembly 102. For example, the compartment 114 includes a door 118 that is hingedly and/or otherwise coupled to the exterior surface 104 of the vehicle 100 to facilitate access to the retractable jumper cable assembly 102. For example, when the retractable jumper cable assembly 102 is not being utilized, the door 118 is closed to protect components of the retractable jumper cable assembly 102 from the environment. Further, the door 118 is opened to enable a user to access and utilize components of the retractable jumper cable assembly 102 for jumping the battery 108 and/or another battery. In the illustrated example, the compartment 114 through which a user accesses the retractable jumper cable assembly 102 is located toward a back of the vehicle 100 on a driver-side. In other examples, the compartment 114 may be located at any other location along the exterior surface 104 of the vehicle 100 that enables the user to quickly and easily access the retractable jumper cable assembly 102.

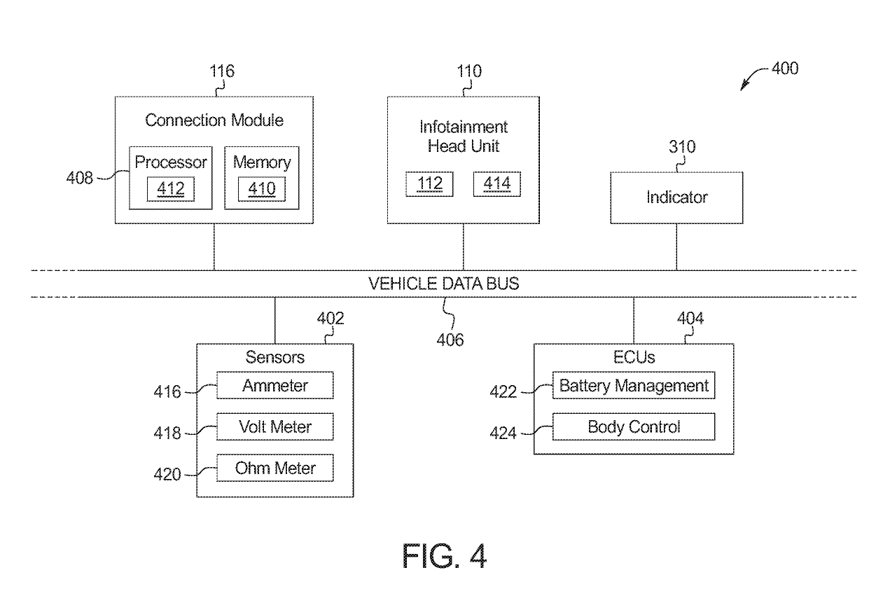

The connection module 116 of the illustrated example is electrically connected to the battery 108 and monitors the battery 108 and its electrical connections to other components (e.g., a battery of another vehicle). For example, the connection module 116 monitors the charge level of the battery 108 of the vehicle 100 and/or the charge level of the other battery that is electrically connected to the battery 108. The connection module 116 compares the charge level of the battery 108 to the charge level of the other battery to determine whether the battery 108 of the vehicle 100 is to provide energy to or receive energy from the other battery. Further, based on its determination, the connection module 116 enables current to flow from or to the battery 108 of the vehicle 100. In some examples, the connection module 116 sends a signal instructing a device to present the charge level of the battery 108 of the vehicle 100 and/or the charge level of the other battery. For example, the connection module 116 sends a signal to the display 112, a speaker (e.g., a speaker 414 of FIG. 4), and/or an indicator (e.g., an indicator 310 of FIGS. 3-4) to present a charge level of one or more batteries.

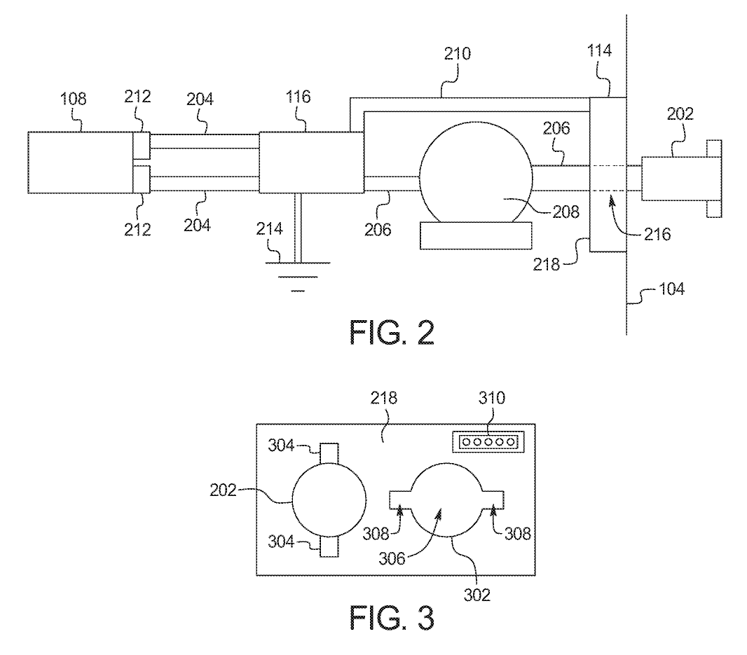

FIG. 2 is a schematic of the retractable jumper cable assembly 102 positioned relative to the exterior surface 104 of the vehicle 100 when the door 118 of the compartment 114 is opened. In the illustrated example, the compartment 114 of the retractable jumper cable assembly 102 is positioned along the exterior surface 104 of the vehicle 100. The retractable jumper cable assembly 102 includes a plug or jumper plug 202 (e.g., a male connector) that extends from the compartment 114 outwardly away from the vehicle 100 (represented by being to the right of the exterior surface 104 in FIG. 2). Further, the retractable jumper cable assembly 102 includes the battery 108, battery cables 204, the connection module 116, a retractable cable 206, a retractor 208, and a receptacle cable 210 that are disposed within the vehicle 100 (represented by being to the left of the exterior surface 104 in FIG. 2).

In the illustrated example, the battery 108 of the vehicle 100 includes leads 212. Each of the battery cables 204 is coupled (e.g., fixedly coupled) to the connection module 116 and a respective one of the leads 212 to electrically connect the connection module 116 to the battery 108. The retractable cable 206 is coupled to the jumper plug 202 and the connection module 116 to electrically connect the jumper plug 202 to the battery 108 via the retractable cable 206, the connection module 116, and the battery cables 204. Additionally, the connection module is connected to ground 214.

As illustrated in FIG. 2, the retractable cable 206 is connected to the retractor 208 in such a manner that the retractor 208 retracts and/or extends a length of the retractable cable 206. For example, the retractor 208 may include an axle around which the retractable cable 206 wraps around and extends from to enable the retractable cable 206 to retract and extend. A portion of the retractable cable 206 extends through an aperture 216 defined by a wall 218 of the compartment 114 to enable the jumper plug 202 connected to the retractable cable 206 to extend into and/or from the compartment 114 as the retractable cable extends and/or retracts. In some examples, the retractor 208 includes an axle that is spring-loaded to bias the retractor 208 and, thus, the retractable cable 206 to retract toward a retracted position. Additionally or alternatively, the jumper plug 202 has a width that is greater than that of the aperture 216 to prevent the jumper plug 202 from passing through the aperture 216 and into a body of the vehicle 100. Further, the receptacle cable 210 is coupled to a jumper receptacle of the retractable jumper cable assembly 102 (e.g., a jumper receptacle 302 of FIG. 3) and the connection module 116 to electrically connect the jumper receptacle to the battery 108 via the receptacle cable 210, the connection module 116, and the battery cables 204.

FIG. 3 is a front view of the compartment 114 of the retractable jumper cable assembly 102 when the door 118 is opened. As illustrated in FIG. 3, a receptacle or jumper receptacle 302 (e.g., a female connector) is fixed to the wall 218 of the compartment 114, and the jumper plug 202 extends into and/or from the compartment 114 via the retractable cable 206 that extends partially through the aperture 216 defined by the wall 218 of compartment 114. For example, the jumper plug 202 is housed in the compartment 114 when the retractable cable 206 is retracted. As illustrated in FIG. 3, the jumper plug 202 includes one or more flanges 304 that protrude outwardly, and the jumper receptacle 302 defines a cavity 306 and one or more slots 308 protruding from the cavity 306. Further, the compartment 114 includes an indicator 310 that is coupled to the wall 218 of the compartment 114.

The jumper plug 202 and the jumper receptacle 302 of the retractable jumper cable assembly 102 enable a user to electrically connect the battery 108 (e.g., a first battery) of the vehicle 100 (e.g., a first vehicle) to a battery (e.g., a second battery) of another vehicle (e.g., a second vehicle) that also includes a retractable jumper cable assembly. For example, the user may electrically connect the battery 108 of the vehicle 100 and the battery of the other vehicle to jump one of the batteries via the other of the batteries. The other vehicle and the retractable jumper cable assembly of the other vehicle include components that are substantially identical to the vehicle and the retractable jumper cable assembly 102 of the vehicle 100 as disclosed in FIGS. 1-3. Accordingly, those components will not be described in detail below.

To jump the battery 108 of the vehicle 100 and/or the battery of the other vehicle utilizing the jumper plug 202 (e.g., a first jumper plug) of the retractable jumper cable assembly 102 (e.g., a first retractable jumper cable assembly), a user opens the door 118 of the compartment 114 and pulls and/or extends the jumper plug 202 away from the compartment 114 via the retractable cable 206. Further, the user connects the jumper plug 202 of the vehicle 100 to a jumper receptacle (e.g., a second jumper receptacle) of a retractable jumper cable assembly (e.g., a second retractable jumper cable assembly) of the other vehicle. For example, to securely connect the jumper plug 202 to the jumper receptacle, the user inserts the flanges 304 of the jumper plug 202 through corresponding slots and into a cavity of the jumper receptacle and subsequently rotates the jumper plug 202 within the cavity such that the flanges 304 deter the jumper plug 202 from being displaced from the cavity. By connecting the jumper plug 202 of the vehicle 100 to the jumper receptacle of the other vehicle, the battery 108 of the vehicle 100 and the battery of the other vehicle are electrically connected for jumping the battery 108 and/or the other battery.

To jump the battery 108 of the vehicle 100 and/or the battery of the other vehicle utilizing the jumper receptacle 302 (e.g., a first jumper receptacle) of the retractable jumper cable assembly 102, a user opens the door 118 of the compartment 114 and pulls and/or extends a jumper plug (e.g., a second jumper plug) of the other vehicle toward the jumper receptacle 302 of the vehicle 100. Further, the user connects the jumper plug of the other vehicle to the jumper receptacle 302 of the vehicle 100. For example, to securely connect the jumper receptacle 302 to the jumper plug, the slots 308 of the jumper receptacle 302 receive corresponding flanges of the jumper plug to enable the cavity 306 of the jumper receptacle 302 to subsequently receive the jumper plug. Further, the user rotates the jumper plug within the cavity 306 of the jumper receptacle 302 such that the jumper plug is prevent from being displaced from the jumper receptacle 302 without further rotation within the cavity 306. By connecting the jumper receptacle 302 of the vehicle 100 to the jumper plug of the other vehicle, the battery 108 of the vehicle 100 and the battery of the other vehicle are electrically connected for jumping the battery 108 and/or the other battery.

In some examples, the connection module 116 detects when the battery 108 of the vehicle 100 is electrically connected, via the jumper plug 202 and/or the jumper receptacle 302, to the battery of the other vehicle. When the battery 108 is electrically connected to the other battery, the connection module 116 detects a charge level (e.g., a first charge level) of the battery 108 of the vehicle 100 and detects a charge level (e.g., a second charge level) of the battery of the other vehicle. The connection module 116 compares the charge levels to determine whether the battery 108 of the vehicle 100 is to jump the battery of the other vehicle or whether the battery 108 of the vehicle 100 is to be jumped by the battery of the other vehicle. Further, the connection module 116 enables the battery 108 to jump the other battery or the other battery to jumper the battery 108 based on the comparison. In some examples, the connection module 116 sends a signal to a device (e.g., the display 112, the indicator 310, a speaker 414 of FIG. 4) to present the charge level of the battery 108 and/or the charge level of the other battery to the user.

Additionally or alternatively, the retractable jumper cable assembly 102 may be utilized to connect an electric charging station. For example, the jumper plug 202 connects to a receptacle of the electric charging station and/or the jumper receptacle 302 receive a plug of the electric charging station to charge the battery 108 of the vehicle 100 via the electric charging station. Further, in some examples, the retractable jumper cable assembly 102 enables batteries of vehicles to be connected in series (i.e., daisy-chained together). For example, a jumper plug of a first vehicle connects to a receptacle of an electric charging station, a jumper plug of a second vehicle connects to a jumper receptacle of the first vehicle, a jumper plug of a second vehicle connects to a jumper receptacle of the second vehicle, etc.

FIG. 4 is a block diagram of electronic components 400 of the vehicle 100. As illustrated in FIG. 4, the electronic components 400 include the connection module 116, the infotainment head unit 110, the indicator 310, sensors 402, electronic control units (ECUs) 404, and a vehicle data bus 406.

The connection module 116 includes a microcontroller unit, controller or processor 408 and memory 410. In some examples, the processor 408 of the connection module 116 is structured to include a charge comparator 412. Alternatively, in some examples, the charge comparator 412 is incorporated into another electronic control unit (ECU) with its own processor 408 and memory 410. For example, the charge comparator 412 detects when the battery 108 of the vehicle 100 is electrically connected to another battery (e.g., of another vehicle), compares the charge level of the battery 108 (e.g., a first charge level) to a charge level of the other battery (e.g., a second charge level), and determines whether the battery is to provide energy to and/or receive energy from the other battery based on the comparison. Further, the processor 408 may be any suitable processing device or set of processing devices such as, but not limited to, a microprocessor, a microcontroller-based platform, an integrated circuit, one or more field programmable gate arrays (FPGAs), and/or one or more application-specific integrated circuits (ASICs).

The memory 410 may be volatile memory (e.g., RAM including non-volatile RAM, magnetic RAM, ferroelectric RAM, etc.), non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc). In some examples, the memory 410 includes multiple kinds of memory, particularly volatile memory and non-volatile memory.

The memory 410 is computer readable media on which one or more sets of instructions, such as the software for operating the methods of the present disclosure, can be embedded. The instructions may embody one or more of the methods or logic as described herein. For example, the instructions reside completely, or at least partially, within any one or more of the memory 410, the computer readable medium, and/or within the processor 408 during execution of the instructions.

The terms “non-transitory computer-readable medium” and “computer-readable medium” include a single medium or multiple media, such as a centralized or distributed database, and/or associated caches and servers that store one or more sets of instructions. Further, the terms “non-transitory computer-readable medium” and “computer-readable medium” include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

The infotainment head unit 110 of the illustrated example includes the display 112 and a speaker 414. For example, the display 112 visually presents and/or the speaker audibly presents the charge level of the battery 108 of the vehicle and/or the charge level of the battery of the other vehicle. Further, the indicator 310 located in the compartment 114 of the retractable jumper cable assembly 102 visually presents the charge level of the battery 108 of the vehicle 100.

The sensors 402 are arranged in and around the vehicle 100 to monitor properties of the vehicle 100 and/or an environment in which the vehicle 100 is located. One or more of the sensors 402 may be mounted to measure properties around an exterior of the vehicle 100. Additionally or alternatively, one or more of the sensors 402 may be mounted inside a cabin of the vehicle 100 or in a body of the vehicle 100 (e.g., an engine compartment, wheel wells, etc.) to measure properties in an interior of the vehicle 100. For example, the sensors 402 include accelerometers, odometers, tachometers, pitch and yaw sensors, wheel speed sensors, microphones, tire pressure sensors, biometric sensors and/or sensors of any other suitable type. In the illustrated example, the sensors 402 include an ammeter 416, a volt meter 418, and an ohmmeter 420. For example, the ammeter 416, the volt meter 418, and/or the ohmmeter 420 are utilized to measure the charge level of the battery 108.

The ECUs 404 monitor and control the subsystems of the vehicle 100. For example, the ECUs 404 are discrete sets of electronics that include their own circuit(s) (e.g., integrated circuits, microprocessors, memory, storage, etc.) and firmware, sensors, actuators, and/or mounting hardware. The ECUs 404 communicate and exchange information via a vehicle data bus (e.g., the vehicle data bus 406). Additionally, the ECUs 404 may communicate properties (e.g., status of the ECUs 404, sensor readings, control state, error and diagnostic codes, etc.) to and/or receive requests from each other. For example, the vehicle 100 may have seventy or more of the ECUs 404 that are positioned in various locations around the vehicle 100 and are communicatively coupled by the vehicle data bus 406. In the illustrated example, the ECUs 404 include a battery management system 422 and body control module 424. For example, the battery management system 422 monitors and manages characteristics of the battery 108, such as a voltage, a current, a state-of-charge, a temperature, etc. Further, the body control module 424 may control one or more subsystems throughout the vehicle 100, such as power windows, power locks, an immobilizer system, power mirrors, etc. For example, the body control module 424 includes circuits that drive one or more of relays (e.g., to control wiper fluid, etc.), brushed direct current (DC) motors (e.g., to control power seats, power locks, power windows, wipers, etc.), stepper motors, LEDs, etc.

The vehicle data bus 406 communicatively couples the infotainment head unit 110, the connection module 116, the indicator 310, the sensors 402, and the ECUs 404. In some examples, the vehicle data bus 406 includes one or more data buses. The vehicle data bus 406 may be implemented in accordance with a controller area network (CAN) bus protocol as defined by International Standards Organization (ISO) 11898-1, a Media Oriented Systems Transport (MOST) bus protocol, a CAN flexible data (CAN-FD) bus protocol (ISO 11898-7) and/a K-line bus protocol (ISO 9141 and ISO 14230-1), and/or an Ethernet™ bus protocol IEEE 802.3 (2002 onwards), etc.

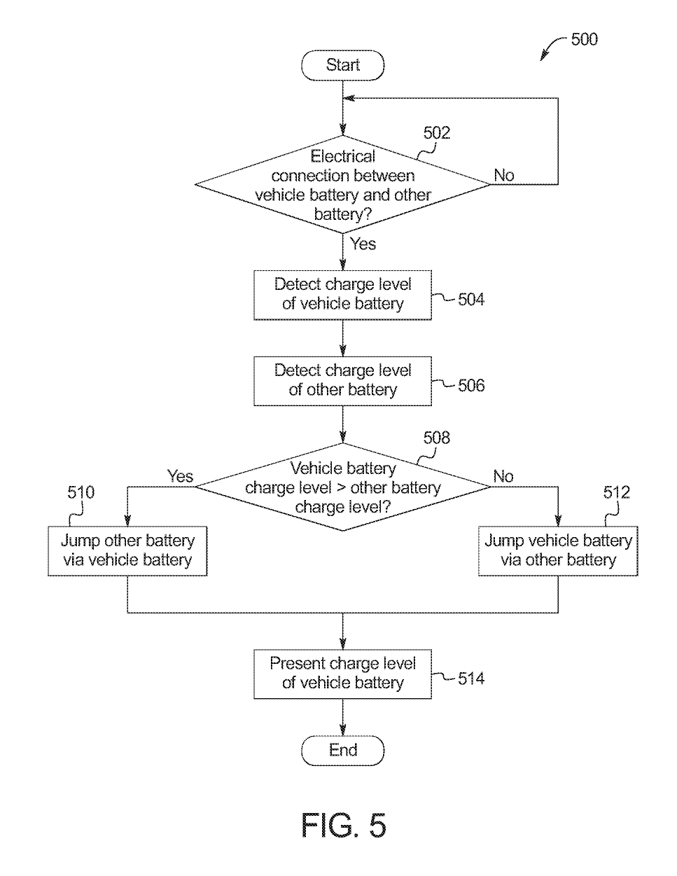

FIG. 5 is a flowchart of an example method 500 to jump a battery of a vehicle via a retractable jumper cable assembly in accordance with the teachings herein. The flowchart of FIG. 5 is representative of machine readable instructions that are stored in memory (such as the memory 410 of FIG. 4) and include one or more programs which, when executed by a processor (such as the processor 408 of FIG. 4), cause the vehicle 100 to implement the example connection module 116 of FIGS. 1-2 and 4. While the example program is described with reference to the flowchart illustrated in FIG. 5, many other methods of implementing the example connection module 116 may alternatively be used. For example, the order of execution of the blocks may be rearranged, changed, eliminated, and/or combined to perform the method 500. Further, because the method 500 is disclosed in connection with the components of FIGS. 1-4, some functions of those components will not be described in detail below.

Initially, at block 502, the connection module 116 determines whether there is an electrical connection between the battery 108 of the vehicle 100 and another battery (e.g., of another vehicle). For example, the connection module 116 determines whether the battery 108 is electrically connected to the other battery via the jumper plug 202 and/or the jumper receptacle 302 of the retractable jumper cable assembly 102. The method 500 remains at block 502 in response to determining that the battery 108 is not connected to another battery. In response to determining that the battery 108 is connected to another battery, the method 500 proceeds to block 504.

At block 504, the connection module 116 detects the charge level of the battery 108 of the vehicle 100. For example, the connection module 116 detects the charge level via the ammeter 416, the volt meter 418, and/or the ohmmeter 420. Further, at block 506, the connection module 116 detects the charge level of the other battery. At block 508, the charge comparator 412 of the connection module 116 compares the charge levels to determine whether the charge level of the battery 108 of the vehicle 100 is greater than the charge level of the other battery. In response to the charge comparator 412 determining that the charge level of the battery 108 is greater than the charge level of the other battery, the method 500 proceeds to block 510 at which the connection module 116 enables the battery 108 of the vehicle 100 to jump the other battery. In response to the charge comparator 412 determining that the charge level of the battery 108 is not greater than the charge level of the other battery, the method 500 proceeds to block 512 at which the connection module 116 enables the other battery to jump the battery 108 of the vehicle 100. At block 514, the connection module 116 sends a signal to a device (e.g., the display 112, the indicator 310, the speaker 414, etc.) to present the charge level of the battery 108 and/or the other battery.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A vehicle comprising:
an exterior surface;
a battery;
a retractable cable;
a jumper plug coupled to the retractable cable and electrically connected to the battery via the retractable cable; and
a compartment along the exterior surface to house the jumper plug when the retractable cable is retracted, wherein, when the retractable cable is extended, the jumper plug extends from the compartment to connect to a receptacle of another vehicle.

2. The vehicle of claim 1, wherein the jumper plug connects to the receptacle of the other vehicle to electrically connect the battery to another battery of the other vehicle.

3. The vehicle of claim 1, wherein the jumper plug has flanges that are configured to be inserted through slots of the receptacle of the other vehicle and subsequently rotated within a cavity of the receptacle to securely connect the jumper plug to the receptacle.

4. The vehicle of claim 1, further including a retractor connected to the retractable cable to enable the retractable cable to retract and extend.

5. The vehicle of claim 1, wherein the compartment includes a jumper receptacle that is electrically connected to the battery and configured to receive a plug of the other vehicle.

6. The vehicle of claim 5, further including a receptacle cable coupled to the jumper receptacle to electrically connect the jumper receptacle and the battery.

7. The vehicle of claim 1, further including a connection module to detect when the jumper plug is electrically connected to the receptacle of the other vehicle.

8. The vehicle of claim 7, wherein the connection module:
detects a first charge level of the battery and a second charge level of the other battery; and
determine whether the battery is to receive or provide energy based on the first charge level and the second charge level.

9. The vehicle of claim 7, further including battery cables coupled to the battery and the connection module.

10. The vehicle of claim 9, wherein the retractable cable is coupled to the connection module such that the jumper plug is electrically connected to the battery via the retractable cable, the connection module, and the battery cables.

11. The vehicle of claim 7, further including a display that presents a charge level of the battery upon receiving a signal from the connection module.

12. The vehicle of claim 1, wherein the compartment includes an indicator to present a charge level of the battery.

13. A vehicle comprising:
an exterior surface;
a compartment located along the exterior surface and including:
a wall defining an aperture; and
a jumper receptacle fixed to the wall and configured to receive a plug of another vehicle to electrically connect vehicle batteries;
a retractable cable partially positioned through the aperture; and
a jumper plug coupled to the retractable cable and housed in the compartment when the retractable cable is retracted.

14. The vehicle of claim 13, wherein the jumper receptacle includes slots configured to receive flanges of the plug of the other vehicle to securely couple the jumper receptacle to the plug.

15. The vehicle of claim 13, wherein, when the retractable cable is extended, the jumper plug is to extend from the compartment and connect to a receptacle of the other vehicle to electrically connect the vehicle batteries.

16. The vehicle of claim 15, wherein the jumper plug includes flanges configured to be inserted through slots of the receptacle of the other vehicle and subsequently rotated within a cavity of the receptacle to securely connect the jumper plug to the receptacle.

17. The vehicle of claim 13, wherein the compartment includes a door coupled to the exterior surface, the door encloses the compartment when in a closed position and provides access to the jumper receptacle and the jumper plug when in an open position.

18. The vehicle of claim 13, further including a retractor connected to the retractable cable to enable the retractable cable to retract and extend.

19. The vehicle of claim 13, wherein the jumper plug is a male electrical connector and the jumper receptacle is a female electrical connector.

20. The vehicle of claim 13, further including a connection module to determine when at least one of the jumper receptacle and the jumper plug is electrically connecting the vehicle batteries.
